(19) United States
(12) Patent Application Publication
(10) Pub. No.: US 2026/0231233 A1
(43) Pub. Date: Aug. 6, 2026

(54) CONTENTION RESOLUTION WINDOW FOR DIVERSITY SLOTTED ALOHA RANDOM ACCESS

(71) Applicant: QUALCOMM Incorporated, San Diego, CA (US)

(72) Inventors: Harikumar KRISHNAMURTHY, San Diego, CA (US); Alberto RICO ALVARINO, San Diego, CA (US); Ayan SENGUPTA, MOUNTAIN VIEW, CA (US)

(21) Appl. No.: 19/531,191

(22) Filed: Feb. 5, 2026

Related U.S. Application Data
(60) Provisional application No. 63/755,137, filed on Feb. 6, 2025.

(51) Int. Cl. H04W 74/0833; H04L 47/283

(52) U.S. Cl. CPC H04W 74/0833; H04L 47/283

(57) ABSTRACT

Methods, systems, and devices for wireless communications are described. A user equipment (UE) may receive a configuration for a group of transmission occasions (TOs) including one or multiple TOs, each TO in the group of TOs including resources shared by multiple UEs for random access messaging. Further, the configuration may be associated with a random access scheme for transmission of random access messages within the multiple TOs. In accordance with the configuration and the random access scheme, the UE may transmit, via one or more (e.g., at least two) TOs of the group of TOs, one or more (e.g., at least two) random access messages. The UE may then monitor for a random access message response within a response window associated with the group of TOs, a beginning of the response window having a start time that is offset in time relative to a last TO of the multiple TOs.

### CROSS REFERENCES

The present application for patent claims benefit of U.S. Provisional Patent Application No. 63/755,137 by KRISHNAMURTHY et al., entitled “CONTENTION RESOLUTION WINDOW FOR DIVERSITY SLOTTED ALOHA RANDOM ACCESS,” filed Feb. 6, 2025, assigned to the assignee hereof, and expressly incorporated herein.

### TECHNICAL FIELD

The following relates to wireless communications, including contention resolution window for diversity slotted ALOHA (DSA) random access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more (e.g., two or more) transmission occasions, transmitting, via one or more (e.g., at least two) transmission occasions of the group of transmission occasions, one or more (e.g., at least two) random access messages in accordance with the configuration and the random access scheme, and monitoring, in response to a transmission of the one or more (e.g., at least two) random access messages, for a random access message response within at least one response window associated with the group of transmission occasions, a beginning of the at least one response window having a start time that occurs at an offset in time (e.g., later in time) relative to a last transmission occasion of the one or more (e.g., two or more) transmission occasions of the group of transmission occasions.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more transmission occasions, transmit, via the one or more (e.g., at least two) transmission occasions of the group of transmission occasions, one or more (e.g., at least two) random access messages in accordance with the configuration and the random access scheme, and monitor, in response to a transmission of the one or more random access messages, for a random access message response within at least one response window associated with the group of transmission occasions, a beginning of the at least one response window having a start time that occurs at an offset in time (e.g., later in time) relative to a last transmission occasion of the one or more transmission occasions of the group of transmission occasions.

Another UE for wireless communications is described. The UE may include means for receiving an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more transmission occasions, means for transmitting, via one or more (e.g., at least two) transmission occasions of the group of transmission occasions, one or more (e.g., at least two) random access messages in accordance with the configuration and the random access scheme, and means for monitoring, in response to a transmission of the one or more random access messages, for a random access message response within at least one response window associated with the group of transmission occasions, a beginning of the at least one response window having a start time that occurs at an offset in time (e.g., later in time) relative to a last transmission occasion of the one or more transmission occasions of the group of transmission occasions.

A non-transitory computer-readable medium storing code for wireless communications is described. The code may include instructions executable by one or more processors (e.g., directly, indirectly, after pre-processing, without pre-processing) to receive an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more transmission occasions, transmit, via one or more (e.g., at least two) transmission occasions of the group of transmission occasions, one or more (e.g., at least two) random access messages in accordance with the configuration and the random access scheme, and monitor, in response to a transmission of the one or more random access messages, for a random access message response within at least one response window associated with the group of transmission occasions, a beginning of the at least one response window having a start time that occurs at an offset in time (e.g., later in time) relative to a last transmission occasion of the one or more transmission occasions of the group of transmission occasions.

Some examples of the method, UEs, and non-transitory computer-readable medium described herein may further include operations, features, means, or instructions for receiving, via the configuration, an indication of the offset in time relative to the last transmission occasion of the one or more transmission occasions of the group of transmission occasions.

Some examples of the method, UEs, and non-transitory computer-readable medium described herein may further include operations, features, means, or instructions for receiving, via the configuration, an indication of the random access scheme and selecting the one or more transmission occasions of the group of transmission occasions in accordance with the random access scheme indicated via the configuration, where transmission of the one or more random access messages via the one or more transmission occasions may be based on the selection.

In some examples of the method, UEs, and non-transitory computer-readable medium described herein, the offset in time of the start time of the at least one response window may be based on an end of the last transmission occasion of the one or more transmission occasions of the group of transmission occasions and a first time offset.

In some examples of the method, UEs, and non-transitory computer-readable medium described herein, the first time offset may be associated with a round trip time between the UE and a network entity.

In some examples of the method, UEs, and non-transitory computer-readable medium described herein, the offset in time of the start time of the at least one response window may be based on a later of an end of a first transmission occasion of the group of transmission occasions and a first time offset or an end of the last transmission occasion of the group of transmission occasions and a second time offset that may be different from the first time offset.

In some examples of the method, UEs, and non-transitory computer-readable medium described herein, the at least one response window may be associated with each transmission occasion of the one or more transmission occasions of the group of transmission occasions.

In some examples of the method, UEs, and non-transitory computer-readable medium described herein, the first time offset may be associated with a round trip time between the UE and a network entity.

In some examples of the method, UEs, and non-transitory computer-readable medium described herein, the offset in time of the start time of the at least one response window may be based on a later of an end of a respective transmission occasion of the group of transmission occasions that may be associated with a first transmission of the at least two random access messages and a first time offset or an end of the last transmission occasion of the group of transmission occasions and a second time offset that may be different from the first time offset.

In some examples of the method, UEs, and non-transitory computer-readable medium described herein, the first time offset may be associated with a round trip time between the UE and a network entity.

In some examples of the method, UEs, and non-transitory computer-readable medium described herein, monitoring for the random access message response may include operations, features, means, or instructions for monitoring for at least two random access message responses within a set of multiple response windows associated with the group of transmission occasions, each response window of the set of multiple response windows being associated with a different transmission occasion of the one or more transmission occasions of the group of transmission occasions, where the set of multiple response windows includes the at least one response window, and where a beginning of a respective response window of the set of multiple response windows may have a start time that may be offset in time relative to the last transmission occasion of the one or more transmission occasions of the group of transmission occasions.

In some examples of the method, UEs, and non-transitory computer-readable medium described herein, the offset in time of the start time of the respective response window may be based on a later of an end of a respective transmission occasion of the one or more transmission occasions of the group of transmission occasions that may be associated with the respective response window and a first time offset or an end of the last transmission occasion of the one or more transmission occasions of the group of transmission occasions and a second time offset that may be different from the first time offset.

In some examples of the method, UEs, and non-transitory computer-readable medium described herein, the first time offset may be associated with a round trip time between the UE and a network entity.

In some examples of the method, UEs, and non-transitory computer-readable medium described herein, the UE may be a half-duplex UE.

In some examples of the method, UEs, and non-transitory computer-readable medium described herein, the random access scheme may be a diversity slotted ALOHA (DSA) scheme.

In some examples of the method, UEs, and non-transitory computer-readable medium described herein, the set of multiple UEs includes the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show an example of a wireless communications system that supports a contention resolution window for diversity slotted ALOHA (DSA) random access in accordance with one or more aspects of the present disclosure.

FIG. 3 shows an example of a timing diagrams that support a contention resolution window for DSA random access in accordance with one or more aspects of the present disclosure.

FIG. 4 shows an example of a process flow that supports a contention resolution window for DSA random access in accordance with one or more aspects of the present disclosure.

FIGS. 5 and 6 show block diagrams of devices that support a contention resolution window for DSA random access in accordance with one or more aspects of the present disclosure.

FIG. 7 shows a block diagram of a communications manager that supports a contention resolution window for DSA random access in accordance with one or more aspects of the present disclosure.

FIG. 8 shows a diagram of a system including a device that supports a contention resolution window for DSA random access in accordance with one or more aspects of the present disclosure.

FIG. 9 shows a flowchart illustrating methods that supports a contention resolution window for DSA random access in accordance with one or more aspects of the present disclosure.

### DETAILED DESCRIPTION

In wireless communication systems, user equipments (UEs) and network entities may establish connections via random access procedures. In some cases, the random access procedures may include contention-based random access procedures where a UE may use contention resolution identifiers and contention resolution windows. For example, in response to transmission of a random access message within a random access procedure, the UE may monitor a contention resolution window (e.g., a response window) for a random access message response (e.g., a Random Access Response (RAR) message, a contention resolution message, and the like) from the network entity. In some cases, for non-terrestrial networks (NTNs), there may be relatively large round trip time (RTT) delays which can lead to delays in random access procedures and random access procedure failures. To reduce the probability of collisions which can cause the delays in random access procedures and can result in random access procedure failures, a UE may use a random access scheme (e.g., a diversity slotted ALOHA (DSA) scheme) where the UE is configured with one or multiple (e.g., two or more) transmission occasions within a transmission occasion group that the UE can choose or select from for transmission of a random access message. Further, each transmission occasion may include a set of resources shared between a set of UEs and the UEs may randomly select a resource within the transmission occasion for transmission of the random access message. Thus, as long as at least one resource and transmission pair in which the UE transmits in does not collide with another UE transmission, the UE may have a successful random access procedure. However, if the UE is a half-duplex UE, a response window for monitoring for a random access response message from the network entity may overlap with a transmission occasion. Such overlay may result in a shortened monitoring period which can cause the UE to miss a response from the network entity thereby increasing the delay in random access procedures.

The techniques of the present disclosure describes techniques for delaying the start of a response window such that when a UE is operating in accordance with the DSA scheme the response window refrains from overlapping with any configured transmission occasion. In some examples, for group-specific or transmission occasion-specific response windows, the start of a response window may be postponed until after the end of a last transmission occasion and a round-trip-time to ensure that there is no overlap between transmission occasions and a response window. In another example, for group-specific response windows, the start of a response window may be postponed until the later of the end of a first transmission occasion and a first time offset (e.g., RTT) or the end of a last transmission occasion in a transmission occasion group and a second time offset (e.g., a small delay that is less than the RTT). Further, for transmission occasion-specific response windows the start of a response window associated with a respective transmission occasion may be postponed until the later of an end of the respective transmission occasion and a first time offset (e.g., RTT) or the end of the last transmission occasion in a transmission occasion group and a second time offset (e.g., a small delay that is less than the RTT). Therefore, using such response window postponements, the UE and the network entity may ensure that the UE can utilize each transmission occasion and the entirety of each response window to reduce the delay in random access procedures. Moreover, reducing random access procedure delays may reduce a quantity and probability of random access failures. Thus, the techniques of the present disclosure may reduce a delay of communications within a wireless communications system and increase the efficiency the wireless communications system.

Aspects of the disclosure are initially described in the context of wireless communications systems. Additional aspects of the disclosure are described with reference to a wireless communications system, timing diagrams, and a process flow. Aspects of the disclosure are further illustrated by and described with reference to apparatus diagrams, system diagrams, and flowcharts that relate to contention resolution window for DSA random access.

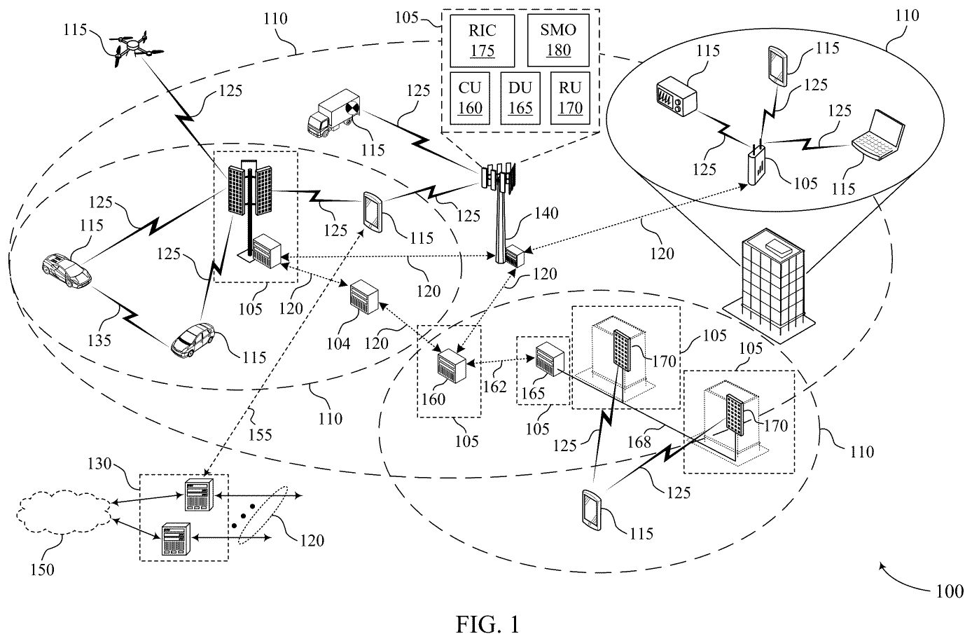

FIG. 1 shows an example of a wireless communications system 100 that supports a contention resolution window for DSA random access in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IT (further enhanced NB-IoT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support contention resolution window for DSA random access as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, UEs 115 and network entities 105 may establish connections via random access procedures (e.g., random access channel (RACH) procedures). In some cases, the random access procedures may include contention-based random access procedures where a UE 115 may use contention resolution identifiers and contention resolution windows. For example, in response to transmission of a random access message withing a random access procedure, the UE 115 may monitor a contention resolution window (e.g., a response window) for a random access message response from the network entity. In some cases, for NTNs (e.g., networks that include satellites as network entities 105), there may be relatively large RTT delays which can lead to delays in random access procedures and random access procedure failures. To reduce the probability of collisions which can cause the delays in random access procedures and can result in random access procedure failures, a UE 115 may use a random access scheme (e.g., a DSA scheme) where the UE 115 is configured with one or multiple (e.g., two or more) transmission occasions within a transmission occasion group that the UE 115 can choose or select from for transmission of a random access message. In some cases, a respective transmission occasion group may include one or more transmission occasions which the UE 115 can choose or select from for transmission of a random access message. Further, each transmission occasion may include a set of resources shared between a set of UEs 115 and the UEs 115 may randomly select a resource within the transmission occasion for transmission of the random access message. In some cases, the set of resources may include a set of different subchannels within a bandwidth or within a transmission time interval (TTI), a set of symbols within a slot, a set of symbol periods, a set of slots, or any combination thereof. Thus, as long as at least one resource and transmission pair in which the UE 115 transmits in does not collide with another UE 115 transmission, the UE 115 may have a successful random access procedure. However, if the UE 115 is a half-duplex UE 115, a response window for monitoring for a random access response message from the network entity may overlap with a transmission occasion. Such overlay may result in a relatively short monitoring period which can cause the UE 115 to miss a response from the network entity 105 thereby increasing the delay in random access procedures.

The techniques of the present disclosure describes techniques for delaying the start of a response window such that when a UE 115 is operating in accordance with the DSA scheme the response window refrains from overlapping with any configured transmission occasion. In some examples, for group-specific or transmission occasion-specific response windows, the start of a response window may be postponed until after the end of a last transmission occasion and a round-trip-time to ensure that there is no overlap between transmission occasions and a response window. In another example, for group-specific response windows, the start of a response window may be postponed until the later of the end of a first transmission occasion and a first time offset (e.g., RTT) or the end of a last transmission occasion in a transmission occasion group and a second time offset (e.g., a relatively small delay that is less than the RTT). Further, for transmission occasion-specific response windows the start of a response window associated with a respective transmission occasion may be postponed until the later of an end of the respective transmission occasion and a first time offset (e.g., RTT) or the end of the last transmission occasion in a transmission occasion group and a second time offset (e.g., a relatively small delay that is less than the RTT). Therefore, using such response window postponements, the UE 115 and the network entity 105 may ensure that the UE 115 can utilize each transmission occasion and the entirety of each response window to reduce the delay in random access procedures. Moreover, reducing random access procedure delays may reduce a quantity and probability of random access failures. Thus, the techniques of the present disclosure may reduce a delay of communications within the wireless communications system 100 and increase the efficiency the wireless communications system 100.

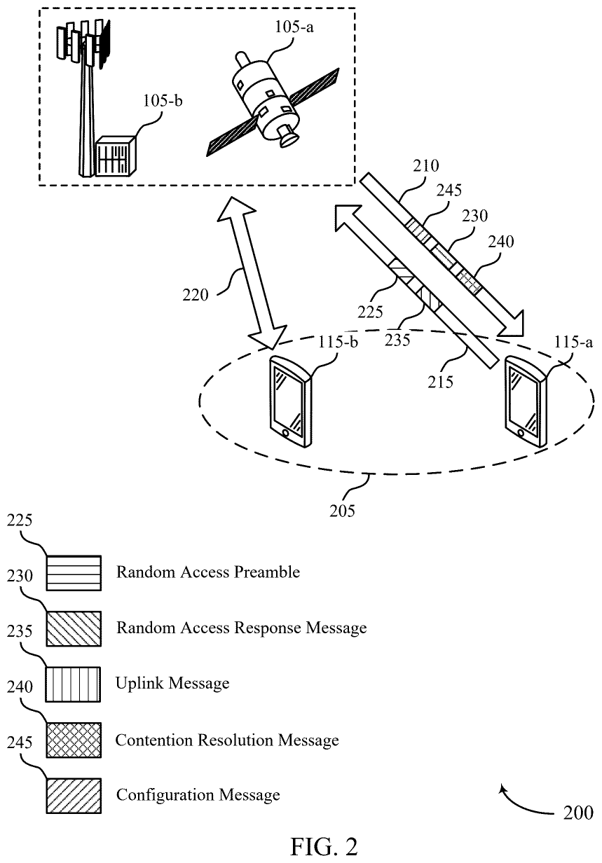

FIG. 2 shows an example of a wireless communications system 200 that supports a contention resolution window for DSA random access in accordance with one or more aspects of the present disclosure. In some examples, the wireless communications system 200 may implement or be implemented by the wireless communications system 100. For example, the wireless communications system 200 may include a network entity 105 (e.g., a network entity 105-a or a network entity 105-b), a UE 115-a, and a UE 115-b, which may represent examples of corresponding devices described herein with reference to FIG. 1. In some cases, the UE 115-a and the UE 115-b may both be within a coverage area 205 that is supported by a network entity 105. Further, the network entity 105-a, the network entity 105-b, or both may communicate with the UE 115-a via a downlink communication link 210 and the UE 115-a may communicate with the network entity 105-a, the network entity 105-b, or both via an uplink communication link 215. Moreover, the network entity 105-a, the network entity 105-b, or both and the UE 115-b may communicate via a communication link 220 that may include separate communication links 125 for uplink communications and downlink communications. Additionally, or alternatively, the downlink communication link 210, the uplink communication link 215, and the communication link 220 may be examples of a communication link 125. The communication link 125 may be examples of a Uu link, a sidelink, a backhaul link, a D2D link or some other type of communication link 125 described herein with reference to FIG. 1.

In some examples, to connect to a network entity 105, a UE 115 may have to perform a random access procedure (e.g., a RACH procedure). In some cases, the random access procedure may be a two-step procedure where at least two messages are exchanged between a UE 115 and a network entity 105. In some other cases, the random access procedure may be four-step random access procedure where at least four messages are exchanged between a UE 115 and a network entity 105. Further, the random access procedure may be a contention-based random access procedure, which may be a four-step random access procedure. For example, if both the UE 115-a and the UE 115-b are attempting to establish a connection with the same network entity 105 (e.g., the network entity 105-a or the network entity 105-b), there may be some message collisions, and the contention-based random access procedure may attempt to mitigate or prevent such collisions.

In a first step of the contention-based random access procedure, a UE 115 (e.g., the UE 115-a, the UE 115-b, or both) may transmit a random access preamble 225 (e.g., a RACH preamble (PRACH) message) to a network entity 105 (e.g., the network entity 105-a or the network entity 105-b). For example, after selecting (e.g., choosing) a random access occasion (e.g., a RACH occasion), the UE 115-a may select the random access preamble 225 uniformly randomly from a set of allowed preambles and transmit the preamble. Additionally, or alternatively, the random access preamble 225 may be a random access-radio network temporary identifier (RNTI). After the transmitting the random access preamble 225, the UE 115-a may wait for a random access response within a random access response (RAR) window.

In response to a network entity 105 correctly receiving the random access preamble 225, the network entity may transmit a random access response message 230 to the UE 115-a. In some examples, the random access response message 230 may include an indication of a random access preamble identifier (RAPID) and other information such as an indication of a timing advance, an uplink grant, a temporary cell radio network temporary identifier (C-RNTI), or any combination thereof. In some other examples, the network entity 105 may respond to the random access preamble 225 with a backoff indication via the random access response message 230 to indicate to the UE 115-a to abandon the current random access procedure. For example, if the network entity 105 is connected to the UE 115-b or is establishing a connection with the UE 115-b and the UE 115-b is expected to utilize most of the bandwidth of the network entity 105, the network entity 105 may indicate for the UE 115-a to abandon the random access procedure accordingly.

In cases where the UE 115-a receives the random access response message 230 within the RAR window from the network entity 105 and the random access response message 230 includes the RAPID that the UE 115-a transmitted via the random access preamble 225, the UE 115-a may transmit an uplink message 235 (e.g., a physical uplink shared channel (PUSCH) message). In some examples, the UE 115-a may scramble the uplink message 235 using the temporary C-RNTI indicated via the random access response message 230. Moreover, the uplink message 235 may include an indication of a contention resolution identifier or a C-RNTI if the network entity 105 refrains from previously indicating a C-RNTI to the UE 115-a.

If the network entity 105 correctly receives the uplink message 235 and the network entity 105 can resolve contention (if any), the network entity 105 may then transmit a contention resolution message 240 to the UE 115-a. In some examples, the contention resolution message 240 may include the contention resolution identifier, C-RNTI, or both that were indicated by the UE 115-a. In some cases, instead of transmitting the contention resolution message 240, the network entity 105 may transmit a retransmission request for the uplink message 235. For example, if the network entity 105 fails to receive the uplink message 235 within a threshold duration, the network entity 105 may transmit a retransmission request for the uplink message 235 that indicates an uplink grant for the retransmission of the uplink message 235.

In cases where the UE 115-a receives the contention resolution message 240 that indicates a contention resolution identity or temporary C-RNTI indicated via the uplink message 235, the UE 115-a may determine that the contention resolution and the random access procedure is successful. Upon determining a successful random access procedure, the UE 115-a may promote the temporary C-RNTI to a C-RNTI and transmit an acknowledgement message back to the network entity 105 indicating acknowledgement of the contention resolution message 240.

As illustrated herein, in some cases, the random access procedure may be for establishing a connection within an NTN. For example, the network entity 105 that the UE 115-a is performing the random access procedure with may be a network entity 105 that is non-terrestrial, such as a satellite (e.g., the network entity 105-a). In some examples, NTNs may have relatively large round trip delays (e.g., relatively larger RTTs or round trip delays (RTDs)). Thus, the end of a response time window for the UE 115-a to receive a random access message response (e.g., the random access response message 230, contention resolution message 240, or both) may have to be relatively larger (e.g., long enough to accommodate for the relatively large RTTs/RTDs in NTNs). However, such response windows may result in relatively larger delays within the wireless communications system 200 when the UE 115-a is unsuccessful in completing the random access procedure on the first try. For example, if there is a collision between the UE 115-a and the UE 115-b (e.g., the UE 115-a and the UE 115-b use the same resources for an uplink transmission), having the UE 115-a transmit the random access preamble 225 or the uplink message 235 multiple times and wait for a response within a response window may result in an increase in delay within the wireless communications system 200 which can reduce the efficiency and reliability of the wireless communications system 200. Further, a collision between the UE 115-a and the UE 115-b may refer to the UE 115-a and the UE 115-b both transmitting an uplink message at the same time such that a network entity 105 is unable to receive both uplink messages. In some cases, when a collision occurs, the network entity 105 may receive one of the two uplink messages or the network entity 105 may be unable to receive either of the two uplink messages, and the network entity 105 may request for one or both of the UEs 115 to retransmit the respective uplink message.

Thus, to reduce the probability of collisions, reduce the probability of random access failures, and reduce the delays within the wireless communications system 200 (e.g., a NTN), a UE 115 (e.g., the UE 115-a) may receive an indication of a configuration 245 (e.g., via a configuration message 245) to utilize a respective random access scheme (e.g., DSA). DSA may be a random access scheme that is an extension of slotted ALOHA where the configuration 245 configures the UE 115-a with N transmission occasions (e.g., RACH preamble occasions, RACH-less early data transmission (EDT) occasions, data transmission occasions, or any combination thereof) within a transmission occasion group. The UE 115-a may then choose k (e.g., 0≤k<N) of the N transmission occasions in the transmission occasion group in which to transmit a random access message (e.g., a random access preamble 225, an uplink message 235). Further, in each of the k occasions the UE 115-a may select (e.g., pick or choose) a resource from a set of/available resources to utilize for the transmission, where/is a positive integer. Additionally, or alternatively, the UE 115-a may randomly select which resource to utilize. Therefore, if at least one resource-transmission occasion pair that the UE 115-a transmits a random access message in does not collide with a transmission from another UE 115 (e.g., the UE 115-b), the UE 115-a random access message transmission may be successful.

For example, the configuration 245 may indicate that a transmission occasion group includes 3 transmission occasions (e.g., N=3) that each include 8 resources. Further, the configuration 245 may configure the UE 115-a with a burst size of 2 (e.g., k=2) such that the UE 115-a has to select at least 2 out of the 3 transmission occasions within the transmission occasion group to transmit a random access message (e.g., a random access preamble 225 or an uplink message 235). Moreover, the UE 115-a may be configured to independently and randomly select a respective resource of a transmission occasion in which to transmit.

Table 1 below illustrates an example of 12 UEs 115 each attempting to connect to a network entity 105 using the DSA scheme. In such examples, each UE 115 of the set of UEs 115 may select a resource within at least two of the transmission occasions to transmit a random access message. In the example illustrated below, UEs 115 B, C, D, E, H, IK, and L may be successful in transmitting a random access message as each UE 115 may have at least one resource within at least one transmission occasion in the transmission occasion group used for a transmission refrain from colliding with a transmission from another UE 115 (e.g., illustrated via the letter being bold and italicized within Table 1 below). Moreover, UEs 115 C, E, I, and L may be the only UEs 115 that have one “non-colliding” transmission within the transmission occasions of the transmission occasion group.

TABLE 1

| | Transmission | Transmission | Transmission |
|---|---|---|---|
| | Occasion #1 | Occasion #2 | Occasion #3 |
| Resource | D | C, F | B |
| #1 | | | |
| Resource | | H | |
| #2 | | | |
| Resource | | E | A, G, I |
| #3 | | | |
| Resource | H | L | E, J |
| #4 | | | |
| Resource | F, L | K | C |
| #5 | | | |
| Resource | B | A, G, J | |
| #6 | | | |
| Resource | | I | D |
| #7 | | | |
| Resource | K | | |
| #8 | | | |

Therefore, the DSA scheme may enable UEs 115 multiple opportunities and chances to successfully transmit a random access message. In some examples, for non-DSA random access, a UE 115 (e.g., the UE 115-a) may begin a response window (e.g., a contention resolution window) one RTT after the end of the random access message transmission (e.g., one RTT after transmitting the uplink message 235). For DSA random access, the UE 115-a may use the same process and begin a response window one RTT from the end of a replica transmission. However, such a procedure may cause issues for half-duplex UEs 115.

In some cases, the UE 115-a may be an example of a half-duplex UE 115 such that the UE 115-a is unable to transmit and receive communications at the same time. In such cases, the network entity 105 (e.g., the network entity 105-a or the network entity 105-b) may ensure that the UE 115-a is not expected to monitor for downlink messages when performing uplink transmissions and vice versa (e.g., that the UE 115-a is not expected to transmit one or more uplink messages when monitoring for one or more downlink messages), which may be important if the network entity 105 responds to the UE 115-a on a per transmission occasion basis. However, in some examples, the transmission occasions within a transmission occasion group may be separated or offset from each other in time. In such examples, a transmission of a random access message for a respective transmission occasion may overlap with a downlink reception window of a different transmission occasion in the transmission occasion group. For example, the UE 115-a may transmit a random access message via a first transmission occasion of a transmission occasion group and a first response window associated with the first transmission occasion may at least partially overlap with a second transmission occasion of the transmission occasion group. In such examples, if the UE 115-a selects or is configured to transmit within the second transmission occasion, the first response window may be shortened which can result in an increase in the delay of a random access procedure.

In another example, the configuration 245 may indicate a transmission occasion group where each transmission occasion is relatively close together. In such examples, an overlap between a response window for a respective transmission occasion and the other transmission occasions may be relatively large resulting in a relatively short available duration where the network entity 105 can expect the UE 115-a to monitor for a random access message response (e.g., a random access response message 230 or a contention resolution message 240). For example, a response window for a first transmission occasion of a transmission occasion group may start at the end of the first transmission plus a RTT which may be towards the beginning of a third transmission occasion within the transmission occasion group. Therefore, the response window may overlap with the third transmission occasion causing the UE 115-a to be unable to monitor for a response during the remainder of the third transmission occasion.

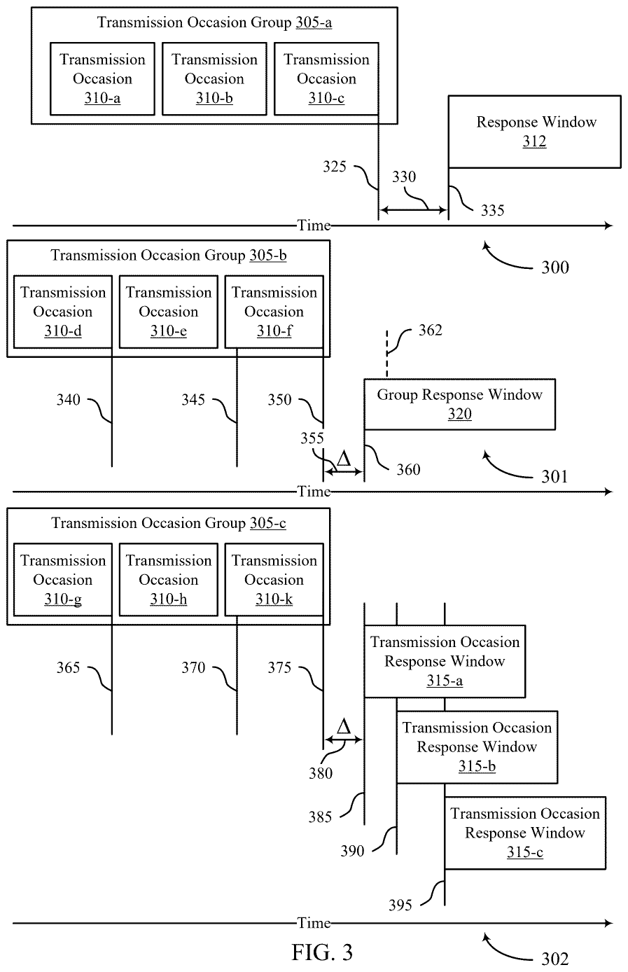

In accordance with the techniques of the present disclosure, to prevent such overlaps between transmission occasions and response windows, the UE 115-a may be configured (e.g., via the configuration 245, other messaging, or negotiations) to monitor for a random access message response within a response window that has a start time that occurs at an offset in time (e.g., later in time) relative to a last transmission occasion of a transmission occasion group. For example, the techniques of the present disclosure may describe the UE 115-a being configured to delay or postpone the start time of monitoring for a random access message (e.g., the random access response message 230 or the contention resolution message 240) within a response window to ensure that the response window refrains from overlapping with any transmission occasions of a transmission occasion group. In some cases, the UE 115-a may receive, via the configuration 245, an indication of the offset in time. Additionally, or alternatively, the UE 115-a may be configured to start to monitor a response window at the later of two times that are associated with different offsets. In some examples, the UE 115-a may also receive an indication of such offsets via the configuration 245. Therefore, based on such offsets, the UE 115-a and the network entity 105 (e.g., the network entity 105-a or the network entity 105-b) may ensure that the UE 115-a can utilize each transmission occasion and can utilize the entirety of each response window. Further, the techniques of the present disclosure may aid in reducing the delay in communications within the wireless communications system 200 which may increase the efficiency and reliability of the wireless communications system 200. Further descriptions of the techniques of the present disclosure may be described elsewhere herein, such as with reference to FIG. 3.

FIG. 3 shows an example of a timing diagram 300, a timing diagram 301, and a timing diagram 302 that supports a contention resolution window for DSA random access in accordance with one or more aspects of the present disclosure. In some examples, the timing diagram 300, the timing diagram 301, and the timing diagram 302 may implement or be implemented by the wireless communications system 100, the wireless communications system 200, or both. For example, the timing diagram 300, the timing diagram 301, and the timing diagram 302 may illustrate timings for response windows associated with transmission occasion groups 305 (e.g., a transmission occasion group 305-a, a transmission occasion group 305-b, and a transmission occasion group 305-c). Further, the transmission occasion groups 305 may each include one or more transmission occasions 310 (e.g., the one or more transmission occasions 310 including two or more transmission occasions). Moreover, a UE 115 may monitor for random access message responses in at least one response window (e.g., a transmission occasion response window 312, a respective transmission occasion response window 315, or a group response window 320) in response to transmission of random access messages within one or more transmission occasions 310 of transmission occasion group 305.

In some examples, as illustrated via the timing diagram 300, a UE 115 may receive an indication of a configuration of the transmission occasion group 305-a that includes a transmission occasion 310-a, a transmission occasion 310-b, and a transmission occasion 310-c. In some cases, the UE 115 may transmit random access messages (e.g., one or more random access messages or at least two random access messages) within the transmission occasions 310 of the transmission occasion group 305-a. In response, the UE 115 may monitor for a random access message response within a transmission occasion response window 315.

In some examples, to ensure a lack of any overlay or overlap between the transmission occasion response window 312 and any of the transmission occasions 310 of the transmission occasion group 305-a, in accordance with the techniques of the present disclosure, the start time of the transmission occasion response window 312 may be delayed (e.g., a network entity 105 may delay the start time of the transmission occasion response window 312) and the time that the UE 115 begins to monitor the transmission occasion response window 312 may be delayed accordingly. For example, a start time for the transmission occasion response window 312 may be offset based on a time 325 that is the end of the last transmission occasion 310 of the transmission occasion group 305-a (e.g., the end of the transmission occasion 310-c) and a RTT 330. The RTT 330 may be associated with a RTT between a UE 115 and a network entity 105 that are associated with the random access procedure. Thus, the start time of the transmission occasion response window 312 may be a time 335 that is after the time 325 plus the RTT 330. In such examples, the transmission occasion response window 312 for each transmission occasion 310 may start at the same time (e.g., the time 335). Therefore, the UE 115 may utilize the transmission occasion response window 312 to monitor for both transmission occasion 310 specific responses (e.g., monitor for responses from each transmission occasion 310) or transmission occasion group 305 specific responses (e.g., monitor for responses for an entire transmission occasion group 305).

In some cases, the UE 115 may be capable of receiving a random access message response that is in response to the transmission occasion 310-a as soon as the transmission occasion 310-c is finished as the time 325 associated with the end of the transmission occasion 310-c may be after a RTT 330 from the end of the transmission occasion 310-a. However, the UE 115 may have to wait an extra RTT 330 before monitoring for a response. Further, as the RTT 330 may be relatively large (e.g., such as in the case of NTNs), such waiting may introduce unnecessary delay into the random access procedure. In some examples, to reduce the delay of when the UE 115 can monitor for a random access message response, the UE 115 may utilize a group response window 320 as illustrated via the timing diagram 301.

In some examples, similar to the timing diagram 300, the timing diagram 301 may illustrate the transmission occasion group 305-b that includes a transmission occasion 310-d, a transmission occasion 310-e, and a transmission occasion 310-f. When the UE 115 utilizes the group response window 320, in accordance with the techniques of the present disclosure, to ensure that the group response window 320 does not overlap with any of the transmission occasions 310 of the transmission occasion group 305-b, the UE 115 may start monitoring for a random access response message within the group response window 320 at the later of two times. For example, the start time of the group response window 320 may be offset in time based on the later of a time 340 plus a first time offset (e.g., a time 345) or a time 350 plus an offset 355 (e.g., a time 360). Further, the time 340 may be an end of the transmission occasion 310-d (e.g., a first transmission occasions 310 of the transmission occasion group 305-b) and the time 345 may be the time 340 plus the RTT 330 between the UE 115 and a network entity 105. Moreover, the time 350 may be the end of the transmission occasion 310-f (e.g., the last transmission occasions 310 of the transmission occasion group 305-b) and the offset 355 may be a time offset that is different from the first time offset (e.g., the offset 355 may be relatively less than the RTT 330 between the UE 115 and the network entity 105). In some cases, the UE 115 may receive an indication of the offset 355 via an indication of a configuration.

Thus, the UE 115 may start monitoring the group response window 320 at a later of an end of the transmission occasion 310-d plus a fixed time offset (e.g., the RTT 330) and an end of the transmission occasion 310-f plus the offset 355. In some cases, if the RTT 330 is relatively large, such delay of the group response window 320 may enable the UE 115 to begin to monitor for random access message responses relatively faster than just the end of the last transmission occasions 310 of a transmission occasion groups 305 and the RTT 330. For example, the UE 115 may receive a response to a transmission within the transmission occasion 310-d as early as the time 360 (e.g., the end of the transmission occasion 310-f plus the offset 355) which may be relatively sooner than the end of the transmission occasion 310-f plus the RTT 330. Therefore, such delay to the start time of the group response window 320 may reduce the delay of the UE 115 receiving a random access response by a time up to the value of the RTT 330.

Additionally, or alternatively, instead of the delay for the group response window 320 being based on the later of an end of a first transmission occasion 310 of a transmission occasion group 305 plus the RTT 330 and the end of the last transmission occasion 310 of the transmission occasion group 305 plus the offset 355, the delay can be based on an end of a first replica transmission within the transmission occasion group 305. Therefore, in such cases, the UE 115 may be configured to delay the start time of monitoring for a random access response message within the group response window 320 by an offset in time where the offset is the later of an end of a first replica transmission (e.g., a repetition of a random access message transmitted in a previous transmission occasion 310 of the transmission group 305) plus the RTT 330 and the time 360. In such cases, the group response window 320 may start at a time 362 which may represent an end of the transmission occasion 310-e (e.g., the first transmission occasion 310 utilized within the transmission occasion group 305-b) and the RTT 330.

In some examples, the UE 115 may also determine or be configured to monitor for random access message responses on a per transmission occasion 310 basis. For example, as illustrated via the timing diagram 302, the UE 115 may be configured with the transmission occasion group 305-c that includes a transmission occasion 310-g, a transmission occasion 310-h, and a transmission occasion 310-k. Further, the UE 115 may monitor for random access message responses in one of multiple transmission occasion response windows 315 where each respective transmission occasion response window 315 is associated with a respective transmission occasion. For example, the UE 115 may utilize a transmission occasion response window 315-a to monitor for messages in response to a transmission within the transmission occasion 310-g, a transmission occasion response window 315-b to monitor for messages in response to a transmission occasion 310-h, and a transmission occasion response window 315-c to monitor for messages in response to a transmission occasion 310-k. In such cases, a start time for a respective transmission occasion response window 315 associated with a respective transmission occasion 310 of the transmission occasion group 305-c may be offset (e.g., may occur at an offset later in time) based on the later of an end of a respective transmission occasion 310 that is associated with the respective transmission occasion response window 315 plus a first time offset (e.g., the RTT 330) and an end of a last transmission occasions 310 of the transmission occasion group 305-c (e.g., the transmission occasion 310-k) plus a second time offset that is different from (e.g., less than) the first time offset.

For example, a start time for the transmission occasion response window 315-a may be based on a later of a time 365 that is the end of the transmission occasion 310-g that is associated with the transmission occasion response window 315-a plus the RTT 330 (e.g., a time 370) and a time 375 that is the end of the transmission occasion 310-k plus an offset 380 (e.g., a time 385). In such case, since the time 385 (e.g., the time 375 that is the end of the transmission occasion 310-k plus the offset 380) is later than the time 370 (e.g., the time 365 that is the end of the transmission occasion 310-g plus the RTT 330), the start of the transmission occasion response window 315-a may be at the time 385. Further, a start time for the transmission occasion response window 315-b may be based on the later of a time 390 that is the end of the transmission occasion 310-h plus the RTT 330 and the time 385. Thus, the start time for the transmission occasion response window 315-b may be the time 390 as the end of the transmission occasion 310-h plus the RTT 330 is later than the end of the transmission occasion 310-k (e.g., the time 375) plus the offset 380 (e.g., the time 385). Moreover, a start time for the transmission occasion response window 315-c may be based on the later of a time 395 that is the end of the transmission occasion 310-k plus the RTT 330 and the time 385. Thus, the start time of the transmission occasion response window 315-c may be the time 395 as the time 395 is later than the time 385. Additionally, or alternatively the transmission occasion response window 315-a, the transmission occasion response window 315-b, and the transmission occasion response window 315-c may each occupy different frequency resource or may each occupy a same frequency resource and overlap in time.

In such examples, the transmission occasion response window 315-a may start at the end of the last transmission occasion 310 of the transmission occasion group 305-c plus the offset 380 as that time is after the time associated with the end of the transmission occasion 310-g plus the RTT 330. Moreover, the transmission occasion response window 315-b and the transmission occasion response window 315-c may both start one RTT 330 after the end of the respective transmission occasion 310 associated with the respective transmission occasion response window 315 as that time may be after the time 385 (e.g., the end of the transmission occasion 310-k plus the offset 380).

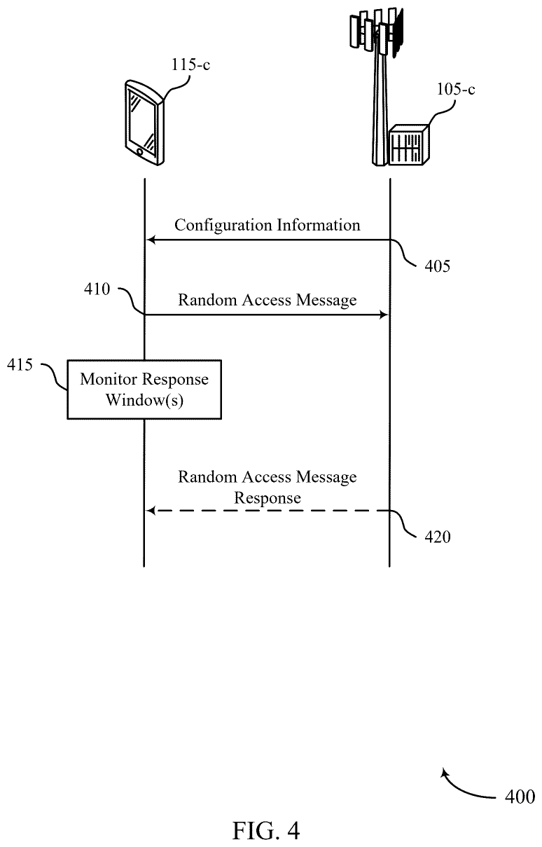

Therefore, in accordance with the techniques of the present disclosure, the network entity 105, the UE 115, or both may ensure that each type of respective response window (e.g., the transmission occasion response window 312, a respective transmission occasion response window 315, or the group response window 320) refrains from overlapping with any of the transmission occasions 310 in any of the transmission occasion groups 305. By preventing such overlapping, the network entity 105, the UE 115, or both may be able to ensure that the UE 115 can utilize each of the transmission occasions 310 and each respective response window which may increase the probability that a random access procedure is successful. Therefore, by increasing the probability of random access procedures being successful, the techniques of the present disclosure may decrease the possible delay in communications of a wireless communication system thus increasing the efficiency and reliability of the wireless communications system. Further descriptions of the techniques of the present disclosure may be described elsewhere herein, such as with reference to FIG. 4.

FIG. 4 shows an example of a process flow 400 that supports a contention resolution window for DSA random access in accordance with one or more aspects of the present disclosure. In some examples, the process flow 400 may implement or be implemented by the wireless communications system 100, the wireless communications system 200, the timing diagram 300, the timing diagram 301, the timing diagram 302, or any combination thereof. For example, the process flow 400 may include a UE 115-c and a network entity 105-c, which may be examples of devices described herein with reference to FIGS. 1 through 3.

In the following description of the process flow 400, the operations between the UE 115-c and the network entity 105-c may be performed in different orders or at different times. Some operations may also be left out of the process flow 400, or other operations may be added. Although the UE 115-c and the network entity 105-c are shown performing the operations of the process flow 400, some aspects of some operations may also be performed by one or more other wireless devices.

At 405, the UE 115-c may receive, from the network entity 105-c, an indication of a configuration for a group of transmission occasions that include one or more (e.g., two or more) transmission occasions. Each transmission occasion in the group of transmission occasions may include a respective set of resources shared by a set of UEs 115 for contention-based random access messaging. Further, the configuration may be associated with a random access scheme (e.g., the DSA scheme) for transmission of multiple random access messages within the one or more transmission occasions. In some examples, the UE 115-c may receive, via the configuration, an indication of the random access scheme. In some cases, the random access scheme may be a DSA scheme. Further, the UE 115-c may be a half-duplex UE 115. Additionally, or alternatively, the set of UEs 115 may include the UE 115-c.

At 410, the UE 115-c may transmit, via the one or more (e.g., at least two) transmission occasions of the group of transmission occasions, one or more (e.g., at least two) random access messages in accordance with the configuration and the random access scheme. In some cases, transmission of the one or more random access messages via the one or more transmission occasions are based on a selection. For example, the UE 115-c may select the one or more (e.g., at least two) transmission occasions of the group of transmission occasions in accordance with the random access scheme indicated via the configuration.

At 415, the UE 115-c may monitor, in response to a transmission of the one or more (e.g., at least two) random access messages, for a random access message response within at least one response window associated with the group of transmission occasions. Further, a beginning of the at least one response window may have a start time that occurs at an offset in time (e.g., later in time) relative to a last transmission occasion of the one or more (e.g., two or more) transmission occasions of the group of transmission occasions. In some cases, the UE 115-c may receive, via the configuration, an indication of the offset in time relative to the last transmission occasion of the one or more transmission occasions of the group of transmission occasions.

In some examples, the offset in time of the start time of the at least one response window may be based on an end of the last transmission occasion of the one or more transmission occasions of the group of transmission occasions and a first time offset. Further, the first time offset may be a RTT between the UE 115-c and the network entity 105-c. In another example, the offset in time of the start time of the at least one response window may be based on a later of an end of a first transmission occasion of the one or more transmission occasions of the group of transmission occasions plus the first time offset (e.g., the RTT) and an end of the last transmission occasion of the one or more transmission occasions of the group of transmission occasions plus a second time offset that is different from the first time offset. In such examples, the at least one response window may be associated with each transmission occasion of the one or more transmission occasions of the group of transmission occasions. Further, in some examples, the offset in time of the start time of the at least one response window is based on a later of an end of a respective transmission occasion of the one or more transmission occasions of the group of transmission occasions that is associated with a first transmission of the one or more (e.g., at least two) random access messages plus the first time offset (e.g., the RTT) and an end of the last transmission occasion of the one or more transmission occasions of the group of transmission occasions plus a second time offset that is different from the first time offset.

In some examples, the UE 115-c may monitor for one or more (e.g., at least two) random access message responses within a set of response windows associated with the group of transmission occasions. In such examples, each response window of the set of response windows may be associated with a different transmission occasion of the one or more (e.g., two or more) transmission occasions of the group of transmission occasions. Additionally, or alternatively, the set of response windows may include the at least one response window. Further, a beginning of a respective response window of the set of response windows has a start time that occurs at an offset in time (e.g., later in time) relative to the last transmission occasion of the one or more transmission occasions of the group of transmission occasions. Moreover, the offset in time of the start time of the respective response window may be based on a later of an end of a respective transmission occasion of the one or more transmission occasions of the group of transmission occasions that is associated with the respective response window plus the first time offset (e.g., the RTT) and an end of the last transmission occasion of the one or more transmission occasions of the group of transmission occasions plus a second time offset that is different from the first time offset. Thus, at 420, in response to the monitoring, the UE 115-c may receive, from the network entity 105-c, the random access message response within the at least one response window that is associated with the group of transmission occasions.

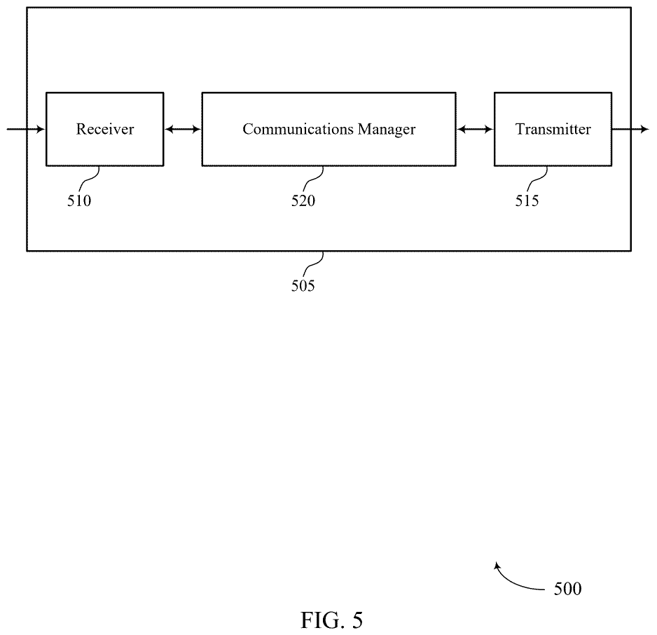

FIG. 5 shows a block diagram 500 of a device 505 that supports a contention resolution window for DSA random access in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to contention resolution window for DSA random access). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to contention resolution window for DSA random access). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of contention resolution window for DSA random access as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein. The communications manager 520, or its sub-components, may be implemented in hardware, software (e.g., executed by a processor), or any combination thereof.

The communications manager 520 may support wireless communications in accordance with examples as disclosed herein. For example, the communications manager 520 is capable of, configured to, or operable to support a means for receiving an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more (e.g., two or more) transmission occasions. The communications manager 520 is capable of, configured to, or operable to support a means for transmitting, via one or more (e.g., at least two) transmission occasions of the group of transmission occasions, one or more (e.g., at least two) random access messages in accordance with the configuration and the random access scheme. The communications manager 520 is capable of, configured to, or operable to support a means for monitoring, in response to a transmission of the one or more (e.g., at least two) random access messages, for a random access message response within at least one response window associated with the group of transmission occasions, a beginning of the at least one response window having a start time that occurs at an offset in time (e.g., later in time) relative to a last transmission occasion of the one or more (e.g., two or more) transmission occasions of the group of transmission occasions.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for ensuring a lack of overlap between transmission occasions and response windows to support reduced processing, reduced power consumption, and more efficient utilization of communication resources.

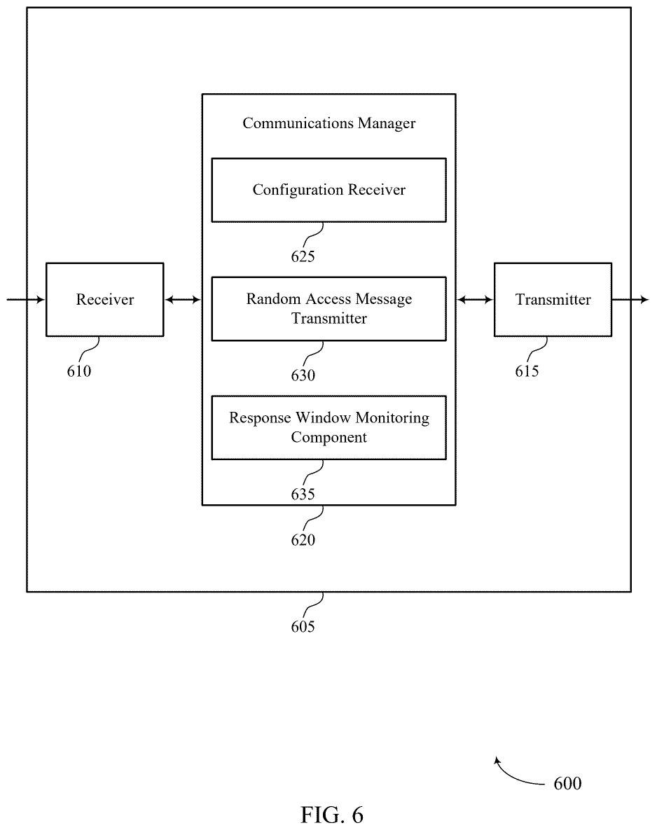

FIG. 6 shows a block diagram 600 of a device 605 that supports a contention resolution window for DSA random access in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to contention resolution window for DSA random access). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to contention resolution window for DSA random access). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of contention resolution window for DSA random access as described herein. For example, the communications manager 620 may include a configuration receiver 625, a random access message transmitter 630, a random access message response monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein. The communications manager 620, or its sub-components, may be implemented in hardware, software (e.g., executed by a processor), or any combination thereof.

The communications manager 620 may support wireless communications in accordance with examples as disclosed herein. The configuration receiver 625 is capable of, configured to, or operable to support a means for receiving an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more (e.g., two or more) transmission occasions. The random access message transmitter 630 is capable of, configured to, or operable to support a means for transmitting, via one or more (e.g., at least two) transmission occasions of the group of transmission occasions, one or more (e.g., at least two) random access messages in accordance with the configuration and the random access scheme. The random access message response monitoring component 635 is capable of, configured to, or operable to support a means for monitoring, in response to a transmission of the one or more (e.g., at least two) random access messages, for a random access message response within at least one response window associated with the group of transmission occasions, a beginning of the at least one response window having a start time that occurs at an offset in time (e.g., later in time) relative to a last transmission occasion of the one or more (e.g., two or more) transmission occasions of the group of transmission occasions.

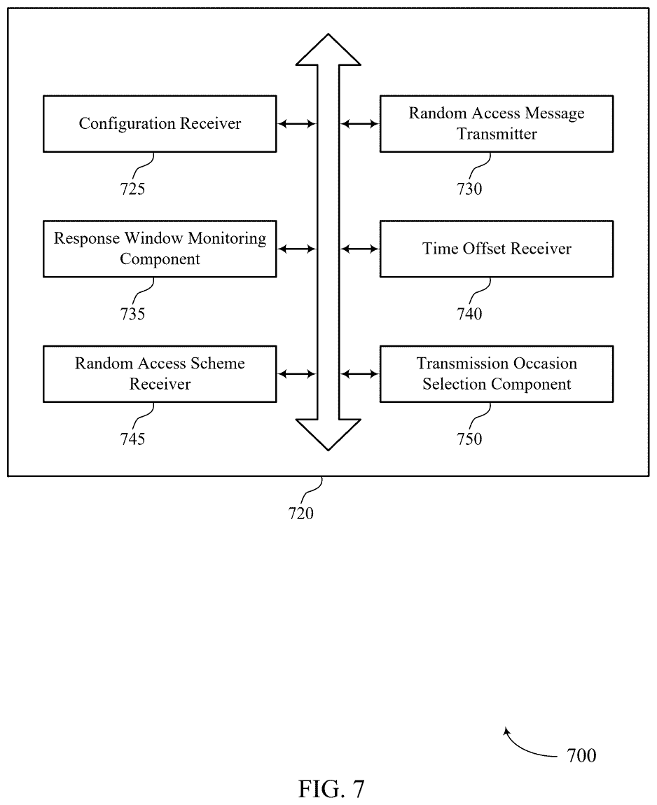

FIG. 7 shows a block diagram 700 of a communications manager 720 that supports a contention resolution window for DSA random access in accordance with one or more aspects of the present disclosure. The communications manager 720 may be an example of aspects of a communications manager 520, a communications manager 620, or both, as described herein. The communications manager 720, or various components thereof, may be an example of means for performing various aspects of contention resolution window for DSA random access as described herein. For example, the communications manager 720 may include a configuration receiver 725, a random access message transmitter 730, a random access message response monitoring component 735, an offset indication receiver 740, a random access scheme indication receiver 745, a transmission occasion selection component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The communications manager 720, or its sub-components, may be implemented in hardware, software (e.g., executed by a processor), or any combination thereof. The configuration receiver 725 is capable of, configured to, or operable to support a means for receiving an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more (e.g., two or more) transmission occasions. The random access message transmitter 730 is capable of, configured to, or operable to support a means for transmitting, via one or more (e.g., at least two) transmission occasions of the group of transmission occasions, one or more (e.g., at least two) random access messages in accordance with the configuration and the random access scheme. The random access message response monitoring component 735 is capable of, configured to, or operable to support a means for monitoring, in response to a transmission of the one or more (e.g., at least two) random access messages, for a random access message response within at least one response window associated with the group of transmission occasions, a beginning of the at least one response window having a start time that occurs at an offset in time (e.g., later in time) relative to a last transmission occasion of the one or more (e.g., two or more) transmission occasions of the group of transmission occasions.

In some examples, the offset indication receiver 740 is capable of, configured to, or operable to support a means for receiving, via the configuration, an indication of the offset in time relative to the last transmission occasion of the two or more transmission occasions of the group of transmission occasions.

In some examples, the random access scheme indication receiver 745 is capable of, configured to, or operable to support a means for receiving, via the configuration, an indication of the random access scheme. In some examples, the transmission occasion selection component 750 is capable of, configured to, or operable to support a means for selecting the one or more (e.g., at least two) transmission occasions of the group of transmission occasions in accordance with the random access scheme indicated via the configuration, where transmission of the one or more (e.g., at least two) random access messages via the one or more (e.g., at least two) transmission occasions is based on the selection.

In some examples, the offset in time of the start time of the at least one response window is based on an end of the last transmission occasion of the one or more transmission occasions of the group of transmission occasions and a first time offset.

In some examples, the first time offset is associated with a round trip time between the UE and a network entity.

In some examples, the offset in time of the start time of the at least one response window is based on a later of an end of a first transmission occasion of the one or more transmission occasions of the group of transmission occasions and a first time offset or an end of the last transmission occasion of the one or more transmission occasions of the group of transmission occasions and a second time offset that is different from the first time offset.

In some examples, the at least one response window is associated with each transmission occasion of the one or more transmission occasions of the group of transmission occasions.

In some examples, the first time offset is associated with a round trip time between the UE and a network entity.

In some examples, the offset in time of the start time of the at least one response window is based on a later of an end of a respective transmission occasion of the one or more transmission occasions of the group of transmission occasions that is associated with a first transmission of the at least two random access messages and a first time offset or an end of the last transmission occasion of the one or more transmission occasions of the group of transmission occasions and a second time offset that is different from the first time offset.

In some examples, the first time offset is associated with a round trip time between the UE and a network entity.

In some examples, to support monitoring for the random access message response, the random access message response monitoring component 735 is capable of, configured to, or operable to support a means for monitoring for one or more (e.g., at least two) random access message responses within a set of multiple response windows associated with the group of transmission occasions, each response window of the set of multiple response windows being associated with a different transmission occasion of the one or more transmission occasions of the group of transmission occasions, where the set of multiple response windows includes the at least one response window, and where a beginning of a respective response window of the set of multiple response windows has a start time that occurs at an offset in time (e.g., later in time) relative to the last transmission occasion of the one or more transmission occasions of the group of transmission occasions.

In some examples, the offset in time of the start time of the respective response window is based on a later of an end of a respective transmission occasion of the two or more transmission occasions of the group of transmission occasions that is associated with the respective response window and a first time offset or an end of the last transmission occasion of the one or more (e.g., two or more) transmission occasions of the group of transmission occasions and a second time offset that is different from the first time offset.

In some examples, the first time offset is associated with a round trip time between the UE and a network entity.

In some examples, the UE is a half-duplex UE.

In some examples, the random access scheme is a DSA scheme.

In some examples, the set of multiple UEs includes the UE.

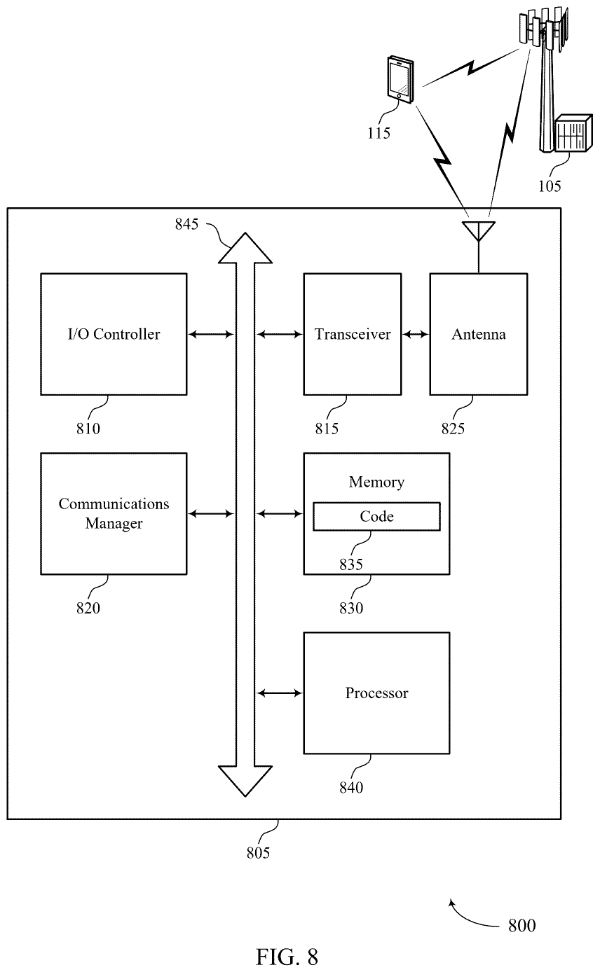

FIG. 8 shows a diagram of a system 800 including a device 805 that supports a contention resolution window for DSA random access in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting contention resolution window for DSA random access). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. The communications manager 820, or its sub-components, may be implemented in hardware, software (e.g., executed by a processor), or any combination thereof. For example, the communications manager 820 is capable of, configured to, or operable to support a means for receiving an indication of a configuration for a group of transmission occasions including two or more transmission occasions, each transmission occasion in the group of transmission occasions including a respective set of resources shared by a set of multiple UEs for contention-based random access messaging, where the configuration is associated with a random access scheme for transmission of multiple random access messages within the two or more transmission occasions. The communications manager 820 is capable of, configured to, or operable to support a means for transmitting, via at least two transmission occasions of the group of transmission occasions, at least two random access messages in accordance with the configuration and the random access scheme. The communications manager 820 is capable of, configured to, or operable to support a means for monitoring, in response to a transmission of the at least two random access messages, for a random access message response within at least one response window associated with the group of transmission occasions, a beginning of the at least one response window having a start time that occurs at an offset in time (e.g., later in time) relative to a last transmission occasion of the two or more transmission occasions of the group of transmission occasions.

By including or configuring the communications manager 820 in accordance with examples as described herein, the device 805 may support techniques for ensuring a lack of overlap between transmission occasions and response windows to support improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of contention resolution window for DSA random access as described herein, or the at least one processor 840 and the at least one memory 830 may be otherwise configured to, individually or collectively, perform or support such operations.

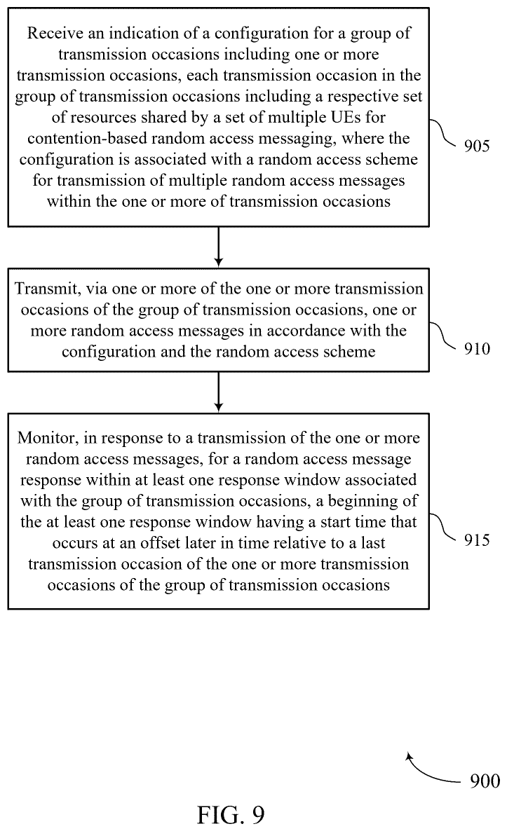

FIG. 9 shows a flowchart illustrating a method 900 that supports a contention resolution window for DSA random access in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving an indication of a configuration for a group of transmission occasions including one or more (e.g., two or more) transmission occasions, each transmission occasion in the group of transmission occasions including a respective set of resources shared by a set of multiple UEs for contention-based random access messaging, where the configuration is associated with a random access scheme for transmission of multiple random access messages within the one or more (e.g., two or more) transmission occasions. The operations of 905 may be performed in accordance with examples as disclosed herein. In some examples, aspects of the operations of 905 may be performed by a configuration receiver 725 as described with reference to FIG. 7.

At 910, the method may include transmitting, via one or more of the one or more (e.g., at least two) transmission occasions of the group of transmission occasions, one or more (e.g., at least two) random access messages in accordance with the configuration and the random access scheme. The operations of 910 may be performed in accordance with examples as disclosed herein. In some examples, aspects of the operations of 910 may be performed by a random access message transmitter 730 as described with reference to FIG. 7.

At 915, the method may include monitoring, in response to a transmission of the one or more (e.g., at least two) random access messages, for a random access message response within at least one response window associated with the group of transmission occasions, a beginning of the at least one response window having a start time that occurs at an offset in time (e.g., later in time) relative to a last transmission occasion of the one or more (e.g., two or more) transmission occasions of the group of transmission occasions. The operations of 915 may be performed in accordance with examples as disclosed herein. In some examples, aspects of the operations of 915 may be performed by a random access message response monitoring component 735 as described with reference to FIG. 7.

The following provides an overview of aspects of the present disclosure:

Aspect 1: A method for wireless communications by a UE, comprising: receiving an indication of a configuration for a group of transmission occasions comprising one or more (e.g., two or more) transmission occasions, each transmission occasion in the group of transmission occasions comprising a respective set of resources shared by a plurality of UEs for contention-based random access messaging, wherein the configuration is associated with a random access scheme for transmission of multiple random access messages within the one or more (e.g., two or more) transmission occasions; transmitting, via one or more of the one or more (e.g., at least two) transmission occasions of the group of transmission occasions, one or more (e.g., at least two) random access messages in accordance with the configuration and the random access scheme; and monitoring, in response to a transmission of the one or more (e.g., at least two) random access messages, for a random access message response within at least one response window associated with the group of transmission occasions, a beginning of the at least one response window having a start time that occurs at an offset in time (e.g., later in time) relative to a last transmission occasion of the one or more (e.g., two or more) transmission occasions of the group of transmission occasions.

Aspect 2: The method of aspect 1, further comprising: receiving, via the configuration, an indication of the offset in time relative to the last transmission occasion of the one or more transmission occasions of the group of transmission occasions.

Aspect 3: The method of any of aspects 1 through 2, further comprising: receiving, via the configuration, an indication of the random access scheme; and selecting the one or more (e.g., at least two) transmission occasions of the group of transmission occasions in accordance with the random access scheme indicated via the configuration, wherein transmission of the one or more (e.g., at least two) random access messages via the one or more (e.g., at least two) transmission occasions is based at least in part on the selection.

Aspect 4: The method of any of aspects 1 through 3, wherein the offset in time of the start time of the at least one response window is based at least in part on an end of the last transmission occasion of the one or more (e.g., two or more) transmission occasions of the group of transmission occasions and a first time offset.

Aspect 5: The method of aspect 4, wherein the first time offset is associated with a round trip time between the UE and a network entity.

Aspect 6: The method of any of aspects 1 through 5, wherein the offset in time of the start time of the at least one response window is based at least in part on a later of an end of a first transmission occasion of the one or more (e.g., two or more) transmission occasions of the group of transmission occasions plus a first time offset and an end of the last transmission occasion of the one or more (e.g., two or more) transmission occasions of the group of transmission occasions plus a second time offset that is different from the first time offset.

Aspect 7: The method of any of aspects 1 through 6, wherein the at least one response window is associated with each transmission occasion of the one or more (e.g., two or more) transmission occasions of the group of transmission occasions.

Aspect 8: The method of any of aspects 6 through 7, wherein the first time offset is associated with a round trip time between the UE and a network entity.

Aspect 9: The method of any of aspects 1 through 8, wherein the at least one response window is associated with a respective transmission occasion and the offset in time of the start time of the at least one response window is based at least in part on a later of an end of the respective transmission occasion of the one or more (e.g., two or more) transmission occasions of the group of transmission occasions that is associated with a first transmission of the one or more (e.g., at least two) random access messages plus a first time offset and an end of the last transmission occasion of the one or more (e.g., two or more) transmission occasions of the group of transmission occasions plus a second time offset that is different from the first time offset.

Aspect 10: The method of aspect 9, wherein the first time offset is associated with a round trip time between the UE and a network entity.

Aspect 11: The method of any of aspects 1 through 10, wherein monitoring for the random access message response comprises: monitoring for one or more (e.g., at least two) random access message responses within a plurality of response windows associated with the group of transmission occasions, each response window of the plurality of response windows being associated with a different transmission occasion of the one or more (e.g., two or more) transmission occasions of the group of transmission occasions, wherein the plurality of response windows comprises the at least one response window, and wherein a beginning of a respective response window of the plurality of response windows has a start time that occurs at an offset in time (e.g., later in time) relative to the last transmission occasion of the one or more (e.g., two or more) transmission occasions of the group of transmission occasions.

Aspect 12: The method of aspect 11, wherein the offset in time of the start time of the respective response window is based at least in part on a later of an end of a respective transmission occasion of the one or more (e.g., two or more) transmission occasions of the group of transmission occasions that is associated with the respective response window plus a first time offset and an end of the last transmission occasion of the one or more (e.g., two or more) transmission occasions of the group of transmission occasions plus a second time offset that is different from the first time offset.

Aspect 13: The method of aspect 12, wherein the first time offset is associated with a round trip time between the UE and a network entity and the second time offset is less than the round trip time.

Aspect 14: The method of any of aspects 1 through 13, wherein the UE is a half-duplex UE.

Aspect 15: The method of any of aspects 1 through 14, wherein the random access scheme is a DSA scheme.

Aspect 16: The method of any of aspects 1 through 15, wherein the plurality of UEs comprises the UE.

Aspect 17: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors (e.g., directly, indirectly, after pre-processing, without pre-processing) to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a configuration for a group of transmission occasions comprising one or more transmission occasions, each transmission occasion in the group of transmission occasions comprising a respective set of resources shared by a plurality of UEs for contention-based random access messaging, wherein the configuration is associated with a random access scheme for transmission of multiple random access messages within the one or more transmission occasions;
transmit, via one or more of the one or more transmission occasions of the group of transmission occasions, one or more random access messages in accordance with the configuration and the random access scheme; and
monitor, in response to a transmission of the one or more random access messages, for a random access message response within at least one response window associated with the group of transmission occasions, a beginning of the at least one response window having a start time that occurs at an offset later in time relative to a last transmission occasion of the one or more transmission occasions of the group of transmission occasions.

2. The UE of claim 1, wherein the one or more processors are individually or collectively further operable to execute the code to cause the UE to:
receive, via the configuration, an indication of the offset in time relative to the last transmission occasion of the one or more transmission occasions of the group of transmission occasions.

3. The UE of claim 1, wherein the one or more processors are individually or collectively further operable to execute the code to cause the UE to:
receive, via the configuration, an indication of the random access scheme; and
select the one or more transmission occasions of the group of transmission occasions in accordance with the random access scheme indicated via the configuration, wherein transmission of the one or more random access messages via the one or more transmission occasions is based at least in part on the selection.

4. The UE of claim 1, wherein the offset in time of the start time of the at least one response window is based at least in part on an end of the last transmission occasion of the one or more transmission occasions of the group of transmission occasions and a first time offset.

5. The UE of claim 4, wherein the first time offset is associated with a round trip time between the UE and a network entity.

6. The UE of claim 1, wherein the offset in time of the start time of the at least one response window is based at least in part on a later of:
an end of a first transmission occasion of the group of transmission occasions plus a first time offset; and
an end of the last transmission occasion of the group of transmission occasions plus a second time offset that is different from the first time offset.

7. The UE of claim 6, wherein the at least one response window is a group response window that is associated with each transmission occasion of the group of transmission occasions.

8. The UE of claim 6, wherein the first time offset is associated with a round trip time between the UE and a network entity.

9. The UE of claim 1, wherein the at least one response window is associated with a respective transmission occasion and the offset in time of the start time of the at least one response window is based at least in part on a later of:
an end of the respective transmission occasion of the one or more transmission occasions of the group of transmission occasions that is associated with a first transmission of the one or more random access messages plus a first time offset; and
an end of the last transmission occasion of the one or more transmission occasions of the group of transmission occasions plus a second time offset that is different from the first time offset.

10. The UE of claim 9, wherein the first time offset is associated with a round trip time between the UE and a network entity.

11. The UE of claim 1, wherein, to monitor for the random access message response, the one or more processors are individually or collectively operable to execute the code to cause the UE to:
monitor for one or more random access message responses within a plurality of response windows associated with the group of transmission occasions, each response window of the plurality of response windows being associated with a different transmission occasion of the one or more transmission occasions of the group of transmission occasions, wherein the plurality of response windows comprises the at least one response window, and wherein a beginning of a respective response window of the plurality of response windows has a start time that occurs at an offset in time relative to the last transmission occasion of the one or more transmission occasions of the group of transmission occasions.

12. The UE of claim 11, wherein the offset in time of the start time of the respective response window is based at least in part on a later of:
an end of a respective transmission occasion of the one or more transmission occasions of the group of transmission occasions that is associated with the respective response window plus a first time offset; and
an end of the last transmission occasion of the one or more transmission occasions of the group of transmission occasions plus a second time offset that is different from the first time offset.

13. The UE of claim 12, wherein the first time offset is associated with a round trip time between the UE and a network entity and the second time offset is less than the round trip time.

14. The UE of claim 1, wherein the UE is a half-duplex UE.

15. The UE of claim 1, wherein the random access scheme is a diversity slotted ALOHA scheme.

16. The UE of claim 1, wherein the plurality of UEs comprises the UE.

17. A method for wireless communications by a user equipment (UE), comprising:
receiving an indication of a configuration for a group of transmission occasions comprising one or more transmission occasions, each transmission occasion in the group of transmission occasions comprising a respective set of resources shared by a plurality of UEs for contention-based random access messaging, wherein the configuration is associated with a random access scheme for transmission of multiple random access messages within the one or more transmission occasions;
transmitting, via one or more of the one or more transmission occasions of the group of transmission occasions, one or more random access messages in accordance with the configuration and the random access scheme; and
monitoring, in response to a transmission of the one or more random access messages, for a random access message response within at least one response window associated with the group of transmission occasions, a beginning of the at least one response window having a start time that occurs at an offset later in time relative to a last transmission occasion of the one or more transmission occasions of the group of transmission occasions.

18. The method of claim 17, further comprising:
receiving, via the configuration, an indication of the offset in time relative to the last transmission occasion of the one or more transmission occasions of the group of transmission occasions.

19. A non-transitory computer-readable medium storing code for wireless communications, the code comprising instructions executable by one or more processors to:
receive an indication of a configuration for a group of transmission occasions comprising one or more transmission occasions, each transmission occasion in the group of transmission occasions comprising a respective set of resources shared by a plurality of UEs for contention-based random access messaging, wherein the configuration is associated with a random access scheme for transmission of multiple random access messages within the one or more transmission occasions;
transmit, via one or more of the one or more transmission occasions of the group of transmission occasions, one or more random access messages in accordance with the configuration and the random access scheme; and
monitor, in response to a transmission of the one or more random access messages, for a random access message response within at least one response window associated with the group of transmission occasions, a beginning of the at least one response window having a start time that occurs at an offset later in time relative to a last transmission occasion of the one or more transmission occasions of the group of transmission occasions.

20. The non-transitory computer-readable medium of claim 19, wherein the instructions are further executable by the one or more processors to:
receive, via the configuration, an indication of the offset in time relative to the last transmission occasion of the one or more transmission occasions of the group of transmission occasions.
